(19) United States
(12) Patent Application Publication
(10) Pub. No.: US 2020/0264984 A1
(43) Pub. Date: Aug. 20, 2020

(54) PARTIAL CACHING OF MEDIA ADDRESS MAPPING DATA

(71) Applicant: Micron Technology, Inc., Boise, ID (US)

(72) Inventors: Lyle E. ADAMS, San Jose, CA (US); Sheng BI, Shanghai (CN); Karl D. SCHUH, Santa Cruz, CA (US); Pushpa SEETAMRAJU, San Jose, CA (US); Dan Z. TUPY, Roseville, CA (US); Yongcai XU, Fremont, CA (US)

(21) Appl. No.: 16/559,031

(22) Filed: Sep. 3, 2019

(30) Foreign Application Priority Data
Feb. 14, 2019 (CN) PCT/CN2019/075106

(51) Int. Cl. G06F 12/1009

(52) U.S. Cl. CPC G06F 12/1009; G06F 2212/657

(57) ABSTRACT

An entry is read from a first memory component, the entry associated with a first logical address. The first entry includes a first physical address to a segment of a logical-to-physical address map in a second memory component and an indication of whether the segment of the logical-to-physical address map is stored in the first memory component. The segment of the logical-to-physical address map includes a second entry associated with the first logical address. A second physical address is written to the second entry in the first memory component based on a determination from the indication that the segment of the logical-to-physical address map is stored in the first memory component.

### CROSS-REFERENCE TO RELATED APPLICATION

The present application claims the benefit of International Application No. PCT/CN2019/075106 filed on Feb. 14, 2019, which is hereby incorporated by reference.

### TECHNICAL FIELD

The present disclosure generally relates to mapping addresses to media, and more specifically, relates to partial caching of media address mapping data.

### BACKGROUND ART

A memory sub-system can be a storage system, such as a solid-state drive (SSD), or a hard disk drive (HDD). A memory sub-system can be a memory module, such as a dual in-line memory module (DIMM), a small outline DIMM (SO-DIMM), or a non-volatile dual in-line memory module (NVDIMM). A memory sub-system can include one or more memory components that store data. The memory components can be, for example, non-volatile memory components and volatile memory components. In general, a host system can utilize a memory subsystem to store data at the memory components and to retrieve data from the memory components.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing environment that includes a memory subsystem in accordance with some embodiments of the present disclosure.

FIG. 2 illustrates an example partial mapping data caching scheme in accordance with some embodiments of the present disclosure.

FIG. 3 is a flow diagram of an example method to access partially cached mapping data in accordance with some embodiments of the present disclosure.

FIG. 4 is a flow diagram of an example method to change partially cached mapping data in accordance with some embodiments of the present disclosure.

FIG. 5 illustrates an example environment to prevent inadvertently overwriting mapping data in accordance with some embodiments of the present disclosure.

FIG. 6 is a flow diagram of an example method to prevent inadvertently overwriting mapping data in accordance with some embodiments of the present disclosure.

FIG. 7 is a block diagram of an example computer system in which embodiments of the present disclosure may operate.

### DETAILED DESCRIPTION

Aspects of the present disclosure are directed to the implementation and management of address mapping data in a memory subsystem. A memory subsystem is also hereinafter referred to as a “memory device.” An example of a memory subsystem is a memory module that is connected to a central processing unit (CPU) via a memory bus. Examples of memory modules include a dual in-line memory module (DIMM), a small outline DIMM (SO-DIMM), a non-volatile dual in-line memory module (NVDIMM), etc. Another example of a memory subsystem is a storage device that is connected to the central processing unit (CPU) via a peripheral interconnect (e.g., an input/output bus, a storage area network, etc.). Examples of storage devices include a solid-state drive (SSD), a flash drive, a universal serial bus (USB) flash drive, and a hard disk drive (HDD). In some embodiments, the memory subsystem is a hybrid memory/storage subsystem. In general, a host system can utilize a memory subsystem that includes one or more memory components. The host system can provide data to be stored at the memory subsystem and can request data to be retrieved from the memory subsystem.

Memory subsystems can employ an indirect address mapping scheme where the host system issues commands to the memory subsystem with an address, sometimes referred to as a “logical” address, and the memory subsystem translates or maps the logical address to another address, sometimes referred to as a “physical” address, that corresponds to the memory cells or structures of the memory subsystem that store data. To perform logical-to-physical address translation, memory subsystems store a map to associate logical addresses with their corresponding physical address, sometimes referred to as a logical-to-physical (“L2P”) map or L2P address map. The memory subsystem uses all or a portion of a logical address to identify an entry in the L2P map that contains the physical address corresponding to the logical address. As an example, a host can have access to 100 physical locations of a memory subsystem via a contiguous block of 100 logical addresses (i.e., from 1-100). Using the L2P map, the memory subsystem translates each logical address to a corresponding physical address (e.g., logical address 1 maps to physical address 26, logical address 2 maps to physical address 3, and so on).

In an exemplary embodiment, the L2P map is stored in a non-volatile memory (e.g., flash memory) to prevent data loss when the memory subsystem is powered down. During operation of the memory subsystem, portions of the L2P map are cached into a volatile memory (e.g., a DRAM or SRAM) that offers higher performance than the non-volatile memory to improve performance associated with address translations. The memory subsystem makes changes to the portions of the L2P map cached into the volatile memory and occasionally writes those portions to the non-volatile memory (e.g., on shutdown, when making room for another portion of the L2P map in the volatile memory, etc.).

The size of the L2P map increases as the amount of data that can be stored within the non-volatile memory increases. For example, a 128-gigabyte (GB) non-volatile memory subsystem can be divided into 33,554,432 addressable pages where each page is 4 kilobytes (KB). To uniquely address each page with 32-bit addressing, an exemplary L2P map would be 128 megabytes (MB). As another example, a 1-terabyte (TB) non-volatile memory subsystem with a similar addressing scheme would result in a 1-GB L2P map. Traditionally, the size of the L2P map was small enough to fit entirely within an amount of space allocated to the L2P map within the volatile memory. However, a combination of increasing densities of non-volatile memories and design constraints limiting the size of the volatile memory can lead to scenarios in which the entirety of the L2P map cannot fit within the volatile memory.

The memory subsystem uses the L2P map for operations other than facilitating host system reads and writes. For example, in some non-volatile memory technologies, such as flash type memory, data must be erased in large blocks that can contain multiple pages of data. Some pages within a block may contain valid data (e.g., data that should be preserved) while other pages containing invalid data may be discarded. To free space, a process, sometimes referred to as garbage collection, moves valid data from a block tagged for erasure to another portion of the non-volatile memory so that the block can be erased. In moving the valid data, the garbage collection process updates the L2P map with the new location of the moved data. When multiple processes read from and write to the L2P map, it is possible for one process to make changes to the physical location of data before updating the L2P map, which can result in other processes receiving out-of-date information when reading the L2P map.

Aspects of the present disclosure address the above and other deficiencies by partially caching the L2P map in volatile memory with a hierarchical L2P map structure. The hierarchy includes at least two levels. A base level of the L2P map contains individual logical-to-physical address mappings and is subdivided into portions. For example, each portion of the L2P map can contain 1,024 individual L2P mappings. These portions of the base level of the L2P map are read from the non-volatile memory into the volatile memory as needed. An index level of the L2P map contains mappings to portions of the base level of the L2P map. The index level of the L2P map tracks the portions of the base level of the L2P map in memory. When a portion of the base level of the L2P map is needed for operations, the memory subsystem checks the index level of the L2P map to determine whether that portion is in the volatile memory. If not, the memory subsystem reads the portion from the non-volatile memory as identified in the index level L2P map and stores the portion in the volatile memory. Since the amount of space allocated for portions of the base level of the L2P map is less than the full size of the L2P map, the memory subsystem swaps portions of the base level of the L2P map between volatile and non-volatile memory. For example, when the memory subsystem determines it needs a portion of the base level L2P map currently stored in the non-volatile memory but there is no room in the volatile memory, the memory subsystem writes another portion of the base level L2P map stored in the volatile memory to the non-volatile memory and reads the needed portion of the base level L2P map into the freed space in the volatile memory. The memory subsystem uses the index level L2P map to track the location of portions of the base level L2P map between volatile memory and non-volatile memory. In this manner, the entirety of the base level of the L2P map need not be stored in the volatile memory. As a result, memory subsystems can have a high non-volatile memory capacity even when the capacity of the volatile memory is limited.

Further aspects of the present disclosure also address the above and other deficiencies by providing a mechanism through which an L2P map entry is updated by one process subject to verification that the same L2P map entry was not modified by another process. An interface to the L2P map provides the current physical address of an entry to a process when reading the L2P map. When the process attempts to write a new physical address to an entry in the L2P map, the process provides the previous physical address obtained from the read as well as the new physical address to the interface. The interface checks the previous physical address against the current physical address in the L2P map and, if the addresses match, updates the L2P map with the new physical address. In this manner, a process is prevented from overwriting more recent data in the L2P map, and other processes are not blocked from accessing the L2P map entry during the period of time between the updating process's read and write.

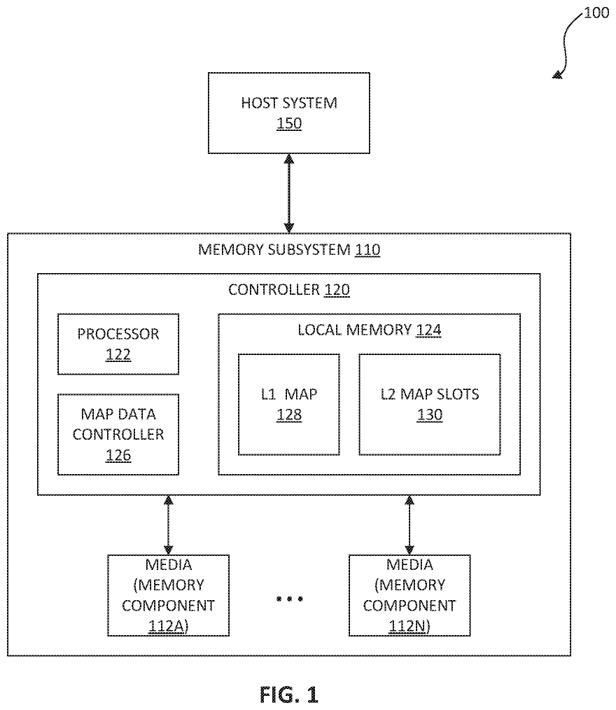

FIG. 1 illustrates an example computing environment 100 that includes a memory subsystem 110 in accordance with some embodiments of the present disclosure. The memory subsystem 110 can include media, such as memory components 112A to 112N. The memory components 112A to 112N can be volatile memory components, non-volatile memory components, or a combination of such. In some embodiments, the memory subsystem is a storage system. An example of a storage system is an SSD. In some embodiments, the memory subsystem 110 is a hybrid memory/storage subsystem. In general, the computing environment 100 can include a host system 150 that uses the memory subsystem 110. For example, the host system 150 can write data to the memory subsystem 110 and read data from the memory subsystem 110.

The host system 150 can be a computing device such as a desktop computer, laptop computer, network server, mobile device, or such computing device that includes a memory and a processing device. The host system 150 can include or be coupled to the memory subsystem 110 so that the host system 150 can read data from or write data to the memory subsystem 110. The host system 150 can be coupled to the memory subsystem 110 via a physical host interface. As used herein, “coupled to” generally refers to a connection between components, which can be an indirect communicative connection or direct communicative connection (e.g., without intervening components), whether wired or wireless, including connections such as electrical, optical, magnetic, etc. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), network interface (e.g., Ethernet-based), etc. The physical host interface can be used to transmit data between the host system 150 and the memory subsystem 110. The host system 150 can further utilize an NVM Express (NVMe) interface to access the memory components 112A to 112N when the memory subsystem 110 is coupled with the host system 150 by a physical host interface such as a PCIe or a network interface. The physical host interface can provide an interface for passing control, address, data, and other signals between the memory subsystem 110 and the host system 150.

The memory components 112A to 112N can include any combination of the different types of non-volatile memory components and/or volatile memory components. An example of non-volatile memory components includes a negative-and (NAND) type flash memory. Each of the memory components 112A to 112N can include one or more arrays of memory cells such as single level cells (SLCs) or multi-level cells (MLCs) (e.g., triple level cells (TLCs) or quad-level cells (QLCs)). In some embodiments, a particular memory component can include both an SLC portion and a MLC portion of memory cells. Each of the memory cells can store one or more bits of data (e.g., data blocks) used by the host system 150. Although non-volatile memory components such as NAND type flash memory are described, the memory components 112A to 112N can be based on any other type of memory such as a volatile memory. In some embodiments, the memory components 112A to 112N can be, but are not limited to, random access memory (RAM), read-only memory (ROM), dynamic random access memory (DRAM), synchronous dynamic random access memory (SDRAM), phase change memory (PCM), magneto random access memory (MRAM), negative-or (NOR) flash memory, electrically erasable programmable read-only memory (EEPROM), and a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. Furthermore, the memory cells of the memory components 112A to 112N can be grouped as memory pages or data blocks that can refer to a unit of the memory component used to store data.

The memory system controller 120 (hereinafter referred to as “controller”) can communicate with the memory components 112A to 112N to perform operations such as reading data, writing data, or erasing data at the memory components 112A to 112N and other such operations. The controller 120 can include hardware such as one or more integrated circuits and/or discrete components, a buffer memory, or a combination thereof. The controller 120 can be a microcontroller, special purpose logic circuitry (e.g., a field programmable gate array (FPGA), an application specific integrated circuit (ASIC), etc.), or another suitable processor. The controller 120 can include a processor (processing device) 122 configured to execute instructions stored in local memory 124. In the illustrated example, the local memory 124 of the controller 120 includes an embedded memory configured to store instructions for performing various processes, operations, logic flows, and routines that control operation of the memory subsystem 110, including handling communications between the memory subsystem 110 and the host system 150. In some embodiments, the local memory 124 can include memory registers storing memory pointers, fetched data, etc. The local memory 124 can also include read-only memory (ROM) for storing micro-code. While the example memory subsystem 110 in FIG. 1 has been illustrated as including the controller 120, in another embodiment of the present disclosure, a memory subsystem 110 may not include a controller 120, and may instead rely upon external control (e.g., provided by an external host, or by a processor or controller separate from the memory subsystem).

In general, the controller 120 can receive commands or operations from the host system 150 and can convert the commands or operations into instructions or appropriate commands to achieve the desired access to the memory components 112A to 112N. The controller 120 can be responsible for other operations such as wear leveling operations, garbage collection operations, error detection and error-correcting code (ECC) operations, encryption operations, caching operations, and address translations between a logical block address and a physical block address that are associated with the memory components 112A to 112N. The controller 120 can further include host interface circuitry to communicate with the host system 150 via the physical host interface. The host interface circuitry can convert the commands received from the host system into command instructions to access the memory components 112A to 112N as well as convert responses associated with the memory components 112A to 112N into information for the host system 150.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the controller 120 and decode the address to access the memory components 112A to 112N.

In some embodiments, the memory subsystem 110 uses a hierarchical L2P map structure to cache portions of the L2P map in local memory 124 while other portions of the L2P map remain in the media (e.g., memory components 112A-112N). The hierarchical L2P map structure includes at least two levels, referred to herein as level 1 (“L1”) and level 2 (“L2”). The L2 map contains individual logical-to-physical address mappings and is subdivided into portions that contain groups of mappings. When the entirety of the L2 map cannot fit into the local memory 124, space allocated for L2P mappings in the local memory 124 is divided into L2 map slots 130 which can be used to cache the portions of the L2 map. Hardware or software of the controller 120 accesses the hierarchical L2P map structure and moves portions of the L2 map between the media and the L2 map slots 130. The hardware or software uses the L1 map to track the location of portions of the L2 map between the media and the L2 map slots 130, as described below. In some embodiments, a hierarchical L2P map can include additional levels to further reduce the size of the L2P mappings in the local memory 124. For example, an L3 map can contain individual logical-to-physical address mappings and be divided into segments, an L2 map can track the location of the L3 map segments and also be divided into segments, and an L1 map can track the location of the L2 map segments.

In some embodiments, the memory subsystem 110 includes the map data controller 126 through which other components of the controller 120 access the L2P mappings. The map data controller 126 moves portions of the L2 map between the L2 map slots 130 and the media 112. In some embodiments, the map data controller 126 prevents separate processes or components of the memory subsystem 110 from inadvertently overwriting L2P map data.

In some embodiments, the controller 120 includes at least a portion of the map data controller 126. For example, the controller 120 can include a processor 122 (processing device) configured to execute instructions stored in local memory 124 for performing the operations associated with the map data controller 126 as described herein. In some embodiments, the map data controller 126 is part of the host system 150, an application, or an operating system. Further details with regards to the operations of the map data controller 126 are described below.

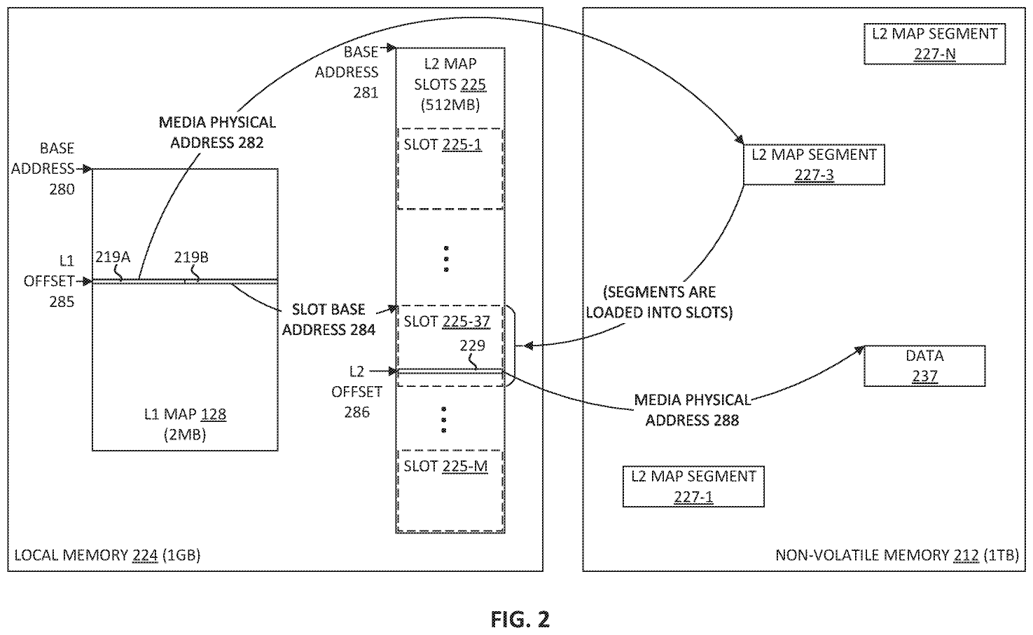

FIG. 2 illustrates an example partial mapping data caching scheme in accordance with some embodiments of the present disclosure. In this example, a memory subsystem includes a non-volatile memory 212 that stores 1 TB of data (e.g., memory components 112) and a local memory 224 that stores 1 GB of data (e.g., local memory 124). As explained above, if the 1 TB non-volatile memory 212 is divided into addressable 4 KB blocks, 268,435,456 addresses are required. If each address is 4 bytes (using 32-bit addressing), the L2P map would require the entirety of the 1 GB local memory 124, which may not be feasible due to competing requirements for space in the local memory 224.

To limit the space requirement for the L2P map, the L2P map is divided into a hierarchical structure including an L1 map 128 and an L2 map 227. The L1 map 128 is used to maintain an index to subdivisions of the L2 map 227. The L2 map is divided into portions or segments 227-1 through 227-N. Each L2 map segment 227 contains a number of L2P addresses. For example, each segment can contain 1,024 physical addresses associated with logical addresses. If each physical address is 32-bits, a single L2 map segment 227 is 4 KB. Although not illustrated in the non-volatile memory 212, the L1 map 128 can be stored in non-volatile memory 212 when power is removed from the memory subsystem and loaded into local memory 224 when power is applied. Similarly, the L2 map segments stored in the local memory 224 can be stored in the non-volatile memory 212 when power is removed from the memory subsystem and loaded, as needed, into the local memory 224 when power is applied. Additionally, L2 map segments that are not stored in local memory 224 are also stored in the in the non-volatile memory 212 and loaded, as needed, into the local memory 224 as described in greater detail below.

The local memory 224 includes L2 map slots 225-1 through 225-M (e.g., L2 map slots 130 in FIG. 1). The memory subsystem can cache an L2 map segment 227 in an L2 map slot 225. If an L2 map segment 227 is required for address translation and not resident in any of the L2 map slots 225, the memory subsystem frees an L2 map slot for the required L2 map segment 227 (if all the slots are used) and copies the required L2 map segment 227 into the freed slot, as described below.

The L1 map 128 and the L2 map slots 225 are located via base addresses 280 and 281, respectively. Base addresses 280, 281 can be determined from configuration data of the memory subsystem or during power up. For example, the processor 122 can, on power up, dynamically allocate space in the local memory 224 for the L1 map 128 and L2 map slots 225. As another example, the location of the L1 map 128 and/or the L2 map slots 225 can be a static address set during the manufacture or factory configuration of the memory subsystem 110. During power up, the processor 122 can load the L1 map and, optionally, segments of the L2 map from persistent storage in the non-volatile memory 212 to the allocated space in the local memory 224.

Each entry in the L1 map corresponds to one of the L2 segments 227-1 through 227-N. As illustrated, entries in the L1 map 128 are identified by an L1 offset 285 from the base address 280. In some embodiments, the L1 offset 285 is determined from a logical address. For example, if there are N L2 map segments, the controller 120 can use log 2 N bits in the logical address to locate an entry in the L1 map 128. As illustrated, an entry in the L1 map 128 includes two fields 219A and 219B. The first field 219A contains a media physical address to an L2 map segment 227 stored in the non-volatile memory 212. As shown, the first field 219A includes a media physical address 282 that identifies L2 map segment 227-3. The second field 219B contains a slot base address corresponding to the L2 map slot 225 where the associated L2 map segment can be found in the local memory 224 (if present). As shown, the second field 219B includes a slot base address 284 that identifies L2 map slot 225-37, assuming the L2 map segment 227-3 is loaded into the L2 map slot 225-37.

In some embodiments, bits in an entry of the L1 map are used to encode various information about the L2 map segment. For example, an entry of the L1 map can include additional bits unrelated to the addressing of the L2 map segments in the local memory 224 and the non-volatile memory 212. In one embodiment, all the bits in the second field 219B are not be needed to identify a particular slot base address, so one or more of the bits can be used to indicate whether the slot base address is valid and/or to encode various status information about the L2 map segment 227. For example, a bit that is not used for addressing can indicate whether an address portion of the second field 219B is valid. As another example, one or more bits that are not used for addressing can indicate some status of the L2 map segment 227, such as whether the L2 map segment 227 is loaded into the local memory 224, is queued for eviction or flushing from the local memory 224 to the non-volatile memory 212, is queued for loading from the non-volatile memory 212, etc. As yet another example, a “dirty” bit that is not used for addressing can indicate whether the L2 map segment has been modified since it was loaded from the non-volatile memory 212 into the local memory 224. If the L2 map segment is not dirty, the processor 122 can avoid the cost of writing it back to non-volatile memory 212 in eviction. In some embodiments, a separate data structure (not shown) can track whether the contents of the second field 219B identifies a valid L2 map segment 227 stored in the local memory 224 and include status information encodings.

If the contents of the second field 219B identify a valid L2 map segment 227 in the local memory 224, entries in the L2 map segment 227 can be used to identify the physical address of data associated with a logical address. Entries in an L2 map segment 227 are identified by an L2 offset 286 from the slot base address 284 from the L1 map 128, where the slot base address 284 is an offset relative to the L2 map slots base address 281. The L2 offset 286 can be determined from a logical address (e.g., from a read or write command from the host system 150). For example, if there are N L2P mappings per L2 map segment 225, the controller 120 can use log 2 N bits in the logical address to locate an entry in the L2 map segment 225. As shown, an entry 229 in the L2 map segment 227-3 includes a media physical address 288 identifying data 237 in the non-volatile memory 212.

L2P lookups using the hierarchical structure illustrated in FIG. 2 can be performed as follows. Based on a logical address, a processing device can identify an entry in the L1 map 128 corresponding to the L2 map segment 227 that contains the physical address associated with the logical address. Assuming the L2P lookup for the logical address is contained in L2 map segment 227-3, the processing device can check whether the second field 219B of the L1 map entry (e.g., at L1 offset 285) points to a slot base address 284 that contains the valid L2 map segment 227-3. If not, the processing device can load the L2 map segment 227-3 from the non-volatile memory 212 to a slot 225 in the L2 map slots 225 based on the physical address in the first field 219A of the L1 map entry. If the valid L2 map segment 227-3 is loaded into slot 225-37, the processing device can lookup the physical address 288 stored in an entry in the L2 map segment based on the slot base address 284 and L2 offset 286 and use that physical address 288 to access the data 237.

Continuing with the example of a 1 GB non-volatile memory 212, if each L2 map segment 227 contains 1,024 L2P addresses, the L1 map 128 contains 262,144 entries to identify each of the L2 map segments 227 in the non-volatile memory 212. Consequently, under 32-bit addressing, the L1 map 128 uses only 1 MB of local memory 224 to locate L2 map segments 227 in the non-volatile memory 212. To facilitate the identification of L2 map segments 227 in either the non-volatile memory 212 or L2 map slots 225, the L1 map 128 is expanded to include two addresses per segment (e.g., in first and second fields 219A and B). If the second field 219B is the same size as the first field 219A, the entirety of the L1 map uses only 2 MB of local memory 224. In some embodiments, the size of the first and second fields 219A and 219B may be different. For example, an address in the second field 219B can be smaller than the addresses in the first field 219A when the number of bits needed to specify a physical address of an L2 map segment in the non-volatile memory 212 is larger than the number of bits needed to specify an address of an L2 map segment in the local memory. If there are 131,072 L2 map slots, 17-bits can uniquely identify each slot. Note that additional bits can be included in the second field 219B for use in encoding the field (e.g., a bit to indicate whether the field includes an address pointing to an L2 map slot that contains the L2 map segment).

By dividing the L2P map into a hierarchical structure, the exemplary L1 map 128 and L2 map slots 225 described above use slightly over half of the local memory 224 as compared to storing the entirety of the L2P map. In particular, the L1 map 128 takes up 2 MB (assuming first and second fields 219A and 219B are the same size) and the L2 map slots 225 takes up 512 MB of 1 GB capacity of the local memory 224.

In some embodiments, more than 32-bits are used for physical addressing of the non-volatile memory 212. For example, a 16 TB capacity non-volatile memory 212 that is divided into 4 KB blocks may use 40-bit addressing.

As illustrated in FIG. 2, the first and second fields 219A and 219B of an entry are interleaved in the L1 map 128. By interleaving the first and second fields 219A and 219B, components accessing the L1 map can perform the access with a single read operation (e.g., reading a wordline in a RAM). In some embodiments, the L1 map can be divided into two data structures with different base addresses for the portion of the L1 map that contains media physical addresses (e.g., first fields 219A) and for the portion of the L1 map that contains slot base addresses (e.g., second fields 219B).

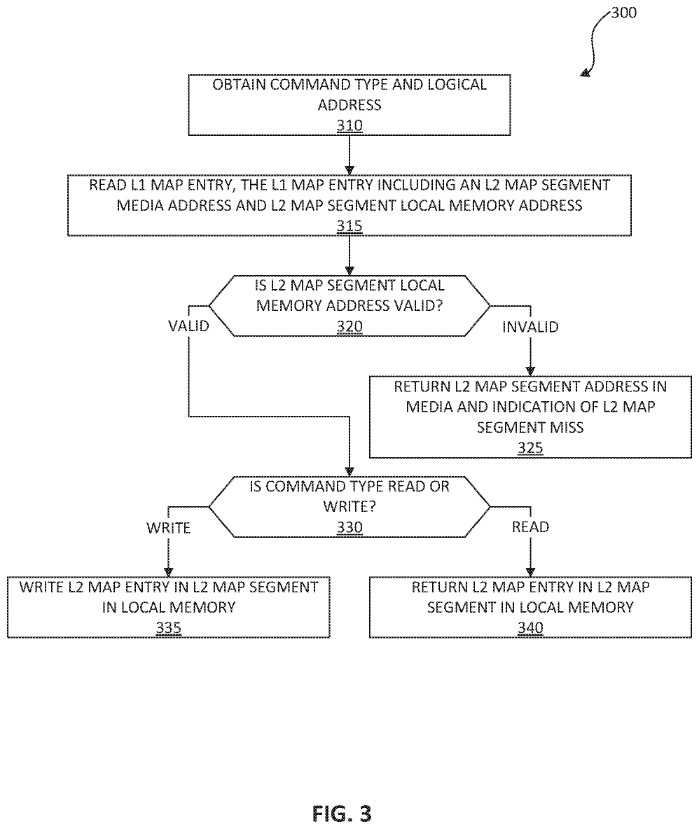

FIG. 3 is a flow diagram of an example method 300 to access partially cached mapping data in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the map data controller 126 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 310, the processing device obtains a command type and a logical address. Commands include read commands and write commands In the case of read commands, the processing device attempts to locate the physical address of data corresponding to the logical address to retrieve the data in the non-volatile memory 212. In the case of write commands, new or updated data has been written to a new physical address in the non-volatile memory 212 and the new physical address needs to be propagated to the L2 map segment. For example, the controller 120 can maintain a write pointer within a segment of media 112 to receive newly written data and, in response to the write command, provide the map data controller 126 with a physical address corresponding to the location of the write pointer.

At block 315, the processing device reads an L1 map entry corresponding to the logical address, the L1 map entry including an L2 map segment media address and an L2 map segment local memory address. As explained with reference to FIG. 2, at least a portion of the logical address can be used to derive an offset to locate an entry within the L1 map in the local memory. For example, some number of bits may be directly used as a pointer to an entry in the L1 map or re-ordered to form a pointer to the entry in the L1 map. Entries in the L1 map include at least two fields: one with the location of the associated L2 map segment in the non-volatile memory 212 (e.g., in the first field 219A) and one with the location of the associated L2 map segment in the local memory if it is loaded into an L2 map slot (e.g., in the second field 219B).

At block 320, the processing device determines whether the L2 map segment is loaded into an L2 map slot in the local memory. Such a determination can be made based on an encoding of the data in the second field 219B or based on another data structure that includes status information related to the L2 map segment. For example, a bit in the second field 219B can indicate whether or not another portion of the second field 219B contains a valid slot base address of the slot in the local memory that contains the L2 map segment. If the processing device determines that the L2 map segment local memory address is invalid, the method 300 continues to block 325. Otherwise, the method 300 continues to block 330.

At block 325, the processing device returns the L2 map segment address in media and an indication that the L2 map segment is not loaded into the local memory. This allows the processing device or other component of the controller 120 to access the L2 map segment in the media and, optionally, load the L2 map segment into a slot 225 in the local memory 224. For example, the map data controller 126 can return the L2 map segment media address in the first field 219A to the processor 122 so that the processor 122 or another component of the controller 120 can access the L2P map segment identified by the first field 219A in the non-volatile memory 212.

At block 330, having determined that the L2 map segment associated with the logical address is loaded into the local memory, the processing device checks whether the command type is a read (to obtain the physical address of data stored in the media) or a write (to update the physical address with a new location of the data stored in the media). If the command is a write to update the L2 map entry, the method 300 continues to block 335. If the command is a read to obtain the physical address from the L2 map entry, the method 300 continues to block 340.

At block 335, when the command is to write an update to an entry in the L2 map segment, the processing device writes an L2 map entry in the L2 map segment in the local memory. As explained with reference to FIG. 2, at least a portion of the logical address can be used to derive an offset to locate an entry within the L2 map segment in the local memory. The updated L2 map entry reflects the new physical address of the data in the media that is associated with the logical address.

At block 340, when the command is to read an entry in the L2 map segment, the processing device returns the L2 map entry in the L2 map segment from the local memory to the processor 122 or to another component of the controller 120. As explained with reference to FIG. 2, at least a portion of the logical address can be used to derive an offset to locate an entry within the L2 map segment in the local memory. The processor 122 or to other component of the controller 120 can use the physical address of the entry in the L2 map segment to obtain the data from the media that corresponds to the logical address associated with the read operation.

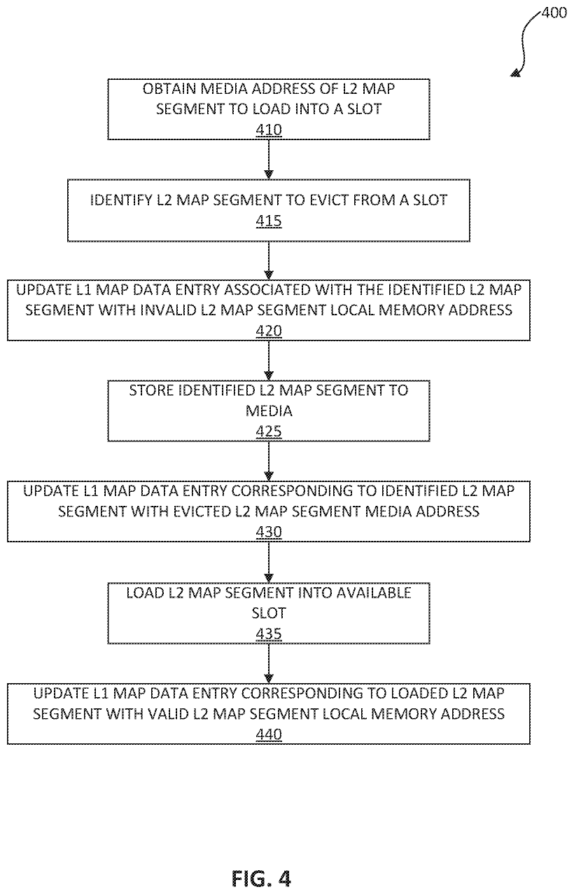

FIG. 4 is a flow diagram of an example method 400 to change partially cached mapping data in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the processor 122 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 410, the processing device obtains a media address of an L2 map segment to load into a slot. For example, when the map data controller 126 determines that an address of an L2 map segment in the local memory 224 is invalid at block 320 of FIG. 3, the map data controller 126 can return the address of the L2 map segment in the non-volatile memory 212 at block 325 to a process executed by the processor 122 or another component of the memory subsystem 110 that manages moving L2 map segments 225 between the local memory 224 and the non-volatile memory 212.

At block 415, the processing device identifies an L2 map segment to evict from an L2 map slot. Various methods of identifying an L2 map segment to evict can be used. For example, the processing device can track when L2 map segments loaded into L2 map slots are used and evict the least recently used L2 map segment. As another example, the processing device can evict an L2 map segment that has not been modified in the local memory 224 to avoid having to store the L2 map segment in the non-volatile memory 212.

At block 420, the processing device updates the entry in the L1 map associated with the L2 map segment identified for eviction to indicate the L2 map segment local memory address is invalid. Once the L2 map segment is identified, the processing device modifies the entry in the L1 map so that subsequent attempts to access the L2 map segment are not fulfilled from the L2 map slot being freed (e.g., so that block 320 evaluates invalid for the evicted L2 map segment).

At block 425, the processing device stores the identified L2 map segment in media. If the L2 map segment being evicted from the local memory 224 has been modified relative to the L2 map segment that was loaded from the non-volatile memory 212, the processing device issues a write operation to the non-volatile memory 212 to write the evicted L2 map segment. In some embodiments, a dirty bit in the L1 map entry for the L2 map segment is used to track whether the L2 map segment has been modified since being loaded into the local memory 224.

At block 430, the processing device updates the entry in the L1 map associated with the evicted L2 map segment with the media address where the evicted L2 map segment was stored. For example, the first field 219A of an entry in the L1 map 128 can be updated with the location where the processing device stored the evicted L2 map segment. In this manner, the next time there is an attempt to access the evicted L2 map segment, the address of the L2 map segment in the non-volatile memory 212 (e.g., first field 219A) can be used to fetch the updated L2 map segment (e.g., via method 400).

At block 435, the processing device loads the L2 map segment from media using the obtained address at block 410 into an available L2 map slot. For example, the processing device issues a read operation to the non-volatile memory 212 to read the L2 map segment identified by the address obtained at block 410 and write the L2 map segment into the freed L2 map slot in the local memory 224.

At block 440, the processing device updates the L1 map entry associated with the loaded L2 map segment with the address of the L2 map slot in which the L2 map segment was loaded. For example, the second field 219B of the L1 map entry associated with the L2 map segment is updated to reflect the presence of the L2 map segment in the local memory 224. In this manner, subsequent attempts to access an L2 map entry within the L2 map segment will identify the L2 map segment as resident in the local memory 224 (e.g., so that block 320 evaluates valid for the loaded L2 map segment).

In some embodiments, if an L2 map slot 225 is empty (e.g., has not been filled), blocks 415 through 430 can be skipped. For example, there may be a time period after power on before all of the L2 map slots 225 have been filled. In some embodiments, if an L2 map segment 227 being evicted from an L2 map slot 225 has not been changed relative to the L2 map segment 227 that was loaded from the non-volatile memory 212, blocks 425 and 430 can be skipped. L2 map segments 227 loaded into L2 map slots may have an associated dirty flag to indicate whether the L2 map segment 227 has been modified in the local memory 224. If the dirty flag is not set, the L2 map segment 227 can be overwritten without writing it in the non-volatile memory 212.

In some embodiments, the method 400 may be performed as part of the method 300. For example, the map data controller 126 can perform the method 400 in place of block 325 of the method 300 (to load the L2 map segment identified as a miss in local memory) and continue to block 330. Doing so, however, may cause other attempts to access L2P mapping data to be blocked while the map data controller 126 is reading an L2 map segment from the media and loading it into an L2 map slot. By returning the media address of an L2 map segment at block 325, the map data controller 126 can continue to service other requests while a separate process loads the L2 map segment into an L2 map slot.

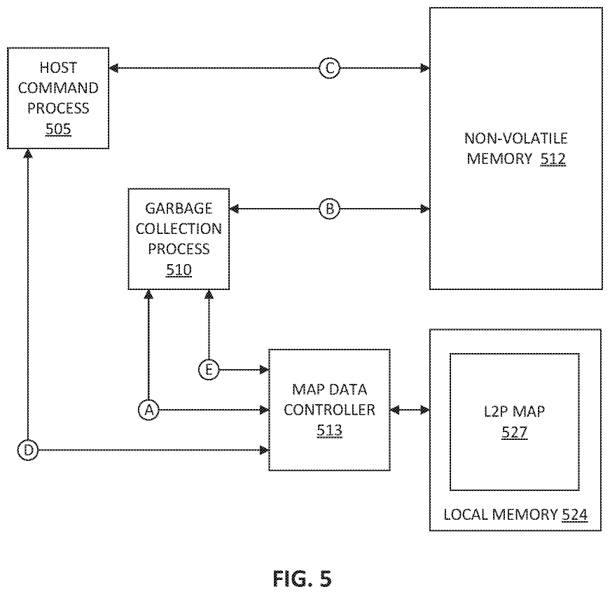

FIG. 5 illustrates an example environment to prevent inadvertently overwriting mapping data in accordance with some embodiments of the present disclosure. Independent, asynchronous, or otherwise uncoordinated processes, components, or aspects of the memory subsystem 110 may rely on L2P mappings in the L2P map 527. The L2P map 527 may be a hierarchical L2P map structure, as described above, or a flat, single-level map.

In the illustrated environment, a host command process 505 and a garbage collection process 510 rely on L2P mappings to access the non-volatile memory 512 (e.g., media 112). The host command process 505 handles read or write commands issued by a host system (e.g., the host system 150 in FIG. 1) by reading data from or writing data to the non-volatile memory 512. The garbage collection process 510 can free up space in the non-volatile memory 512 by moving valid data (e.g., data that is still needed) from portions of the non-volatile memory 512 that contain invalid data (e.g., data that is no longer needed) so those portions can be erased and freed for reuse. As such, the garbage collection process 510 also reads data from and writes data to the non-volatile memory 512.

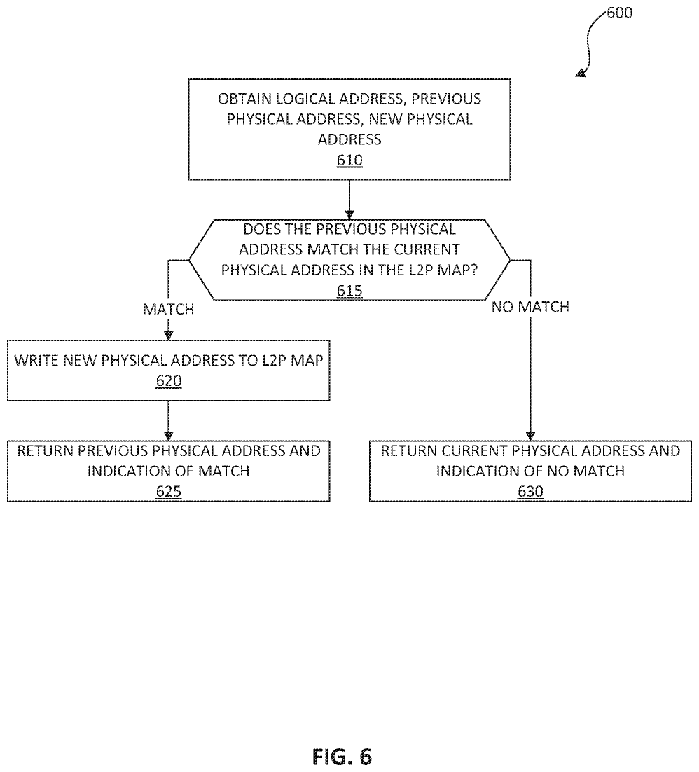

An exemplary sequence of operations is described with reference to the encircled letters A through E. At circle A, the garbage collection process 510 accesses the L2P map 527 via the map data controller 513 to obtain the current physical address of data stored in the non-volatile memory 512 having a logical address. At circle B, the garbage collection process 510 moves the data item to a new physical address in the non-volatile memory. At circle C, the host command process 510 receives a write operation (e.g., from the host system 150) to write to the same logical address that the garbage collection process 510 is in the process of relocating from the current physical address in the L2P map 527 to a new physical address. At circle D, the host command process 510 commands the map data controller 513 to write the physical address of the data written at circle C to the L2P map 527. At circle E, the garbage collection process 510 commands the map data controller 513 to write the new physical address of the data written at circle B to the L2P map 527. Absent protections, an update of the L2P map 527 in response to the command by the garbage collection process 510 at circle E would cause the physical address of the data written at circle C, and thus the most recent data written by the host, to be lost. To prevent this scenario from happening, the map data controller 513 includes logic to prevent such data loss. At a high level, the map data controller 513 verifies that the physical address update requested by the garbage collection process 510 at circle E is based on information that has not changed since the garbage collection process 510 obtained the physical address of the data at circle A. Additional details regarding the protection of the L2P map 527 from such inadvertent updates is provided below with reference to FIG. 6. Note that in some embodiments, another process (not shown) can obtain the current physical address of the data stored in non-volatile memory 512 that is later used by the garbage collection process. Other sequences of operations can exist in which separate processes could cause data loss absent protection.

FIG. 6 is a flow diagram of an example method 600 to prevent inadvertently overwriting mapping data in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the map data controller 126 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 610, the processing device obtains a logical address, the previous physical address of the logical address, and a new physical address for the logical address during garbage collection. For example, at circle E in FIG. 5, the map data controller 513 receives the logical, previous physical, and new physical addresses from the garbage collection process 510. The previous physical address corresponds to the physical address the garbage collection process 510 obtained at circle A for the logical address, and the new physical address corresponds to the new location in the non-volatile memory 512 where the garbage collection process 510 relocated the data that was stored at the previous physical address. Note that the garbage collection process 510 can store the previous physical address to provide it to the map data controller 513.

At block 615, the processing device checks whether the previous physical address matches the current physical address in the L2P map. For example, the processing device compares the physical addresses in response to the garbage collection process 510 folding or otherwise moving valid data from the previous physical address to the new physical address. In one embodiment, the map data controller 513 accesses the L2P map entry associated with the logical address. If the map data controller 513 determines that the previous and current physical addresses match, the method 600 continues to block 620. Otherwise, the method 600 continues to block 630.

At block 620, the processing device writes the new physical address to the L2P map entry associated with the logical address. A match at block 615 indicates that another process has not written to the L2P map entry associated with the logical block address since the process that provided the previous physical address had obtained the previous physical address. In the sequence of operations described with reference to FIG. 5, such a scenario would correspond to the case where the host command process 505 did not cause an update to the L2P map 527 at circle D between circles A and E. Since there was no intervening change to the L2P map entry associated with the logical address, the map data controller 513 can update the L2P map without risk of losing data.

At block 625, the processing device returns the previous physical address and an indication of the match. For example, the map data controller 513 can respond to the garbage collection process 510 with an indication that the L2P update command at circle E was successful. In some embodiments, the processing device only returns an indication of the match.

At block 630, the processing device returns the current physical address and an indication of the mismatch. For example, the map data controller 513 can respond to the garbage collection process 510 with an indication that the L2P update command at circle E was unsuccessful. In some embodiments, the processing device only returns an indication of the mismatch.

In some embodiments, the processing device obtains a mask for use in the comparison at block 615. As described elsewhere herein, entries in the L2P map may contain bits that are used as flags or indicators and unassociated with the physical address. In such cases, the processing device can obtain a mask from, for example, configuration data or from the process requesting the L2P map update. When performing the comparison, the processing device masks the bits in the L2P map entry that are unassociated with the previous physical address obtained at block 610.

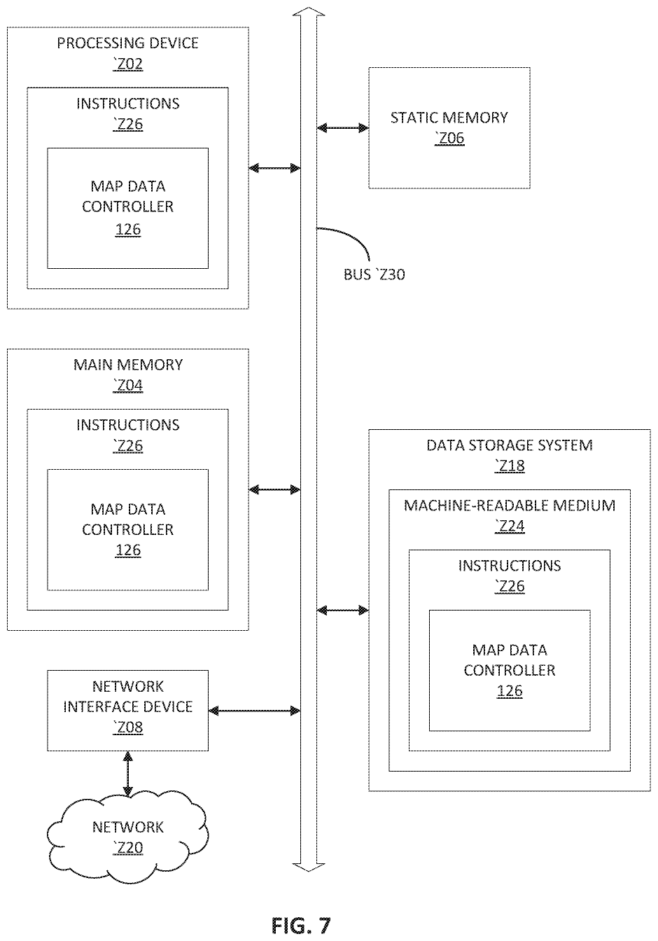

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 150 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the map data controller 126 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory subsystem 110 of FIG. 1.

In one embodiment, the instructions 726 include instructions to implement functionality corresponding to a map data controller (e.g., the map data controller 126 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

### EXAMPLES

Example 1 provides a method. The method of example 1 includes reading a first entry associated with a first logical address from a first memory component. The first entry includes a first physical address to a segment of a logical-to-physical address map in a second memory component and an indication of whether the segment of the logical-to-physical address map is stored in the first memory component. The segment of the logical-to-physical address map includes a second entry associated with the first logical address. The method of example 1 further includes writing, based on a determination from the indication that the segment of the logical-to-physical address map is stored in the first memory component, a second physical address to the second entry in the first memory component.

Example 2 includes the subject matter of example 1. The method of example 2 further includes reading, based on a determination from the indication that the segment of the logical-to-physical address map is not stored in the first memory component, the segment of the logical-to-physical address map from the first physical address of the second memory component. The method of example 2 further includes writing the segment of the logical-to-physical address map to a location in the first memory component and updating the first entry associated with the first logical address in the first memory component to include an indication of the location.

Example 3 includes the subject matter of example 2. The method of example 3 further includes reading another segment of the logical-to-physical address map from the location in the first memory component prior to writing the segment of the logical-to-physical address map to the location in the first memory component. The method of example 3 further includes writing the other segment of the logical-to-physical address map to the second memory component.

Example 4 includes the subject matter of example 3. The method of example 4 further includes updating a third entry associated with the other segment of the logical-to-physical address map in the first memory component with an indication that the other segment of the logical-to-physical address map is not stored in the first memory component.

Example 5 includes the subject matter of any one of examples 1 to 4. The method of example 5 further includes determining, prior to writing the second physical address to the second entry in the first memory component, that the second entry in the first memory component contains a current physical address that matches a previous physical address.

Example 6 includes the subject matter of any one of examples 1 to 5. In example 6, a location of the first entry in the first memory component is identified based on a first portion of the first logical address, and a location of the second entry in the segment of the logical-to-physical address map in the second memory component is identified based on a second portion of the first logical address.

Example 7 includes the subject matter of any one of examples 1 to 6. In example 7, the indication is based on an encoding of at least a portion of the first entry.

Example 8 provides a non-transitory computer-readable storage medium. The non-transitory computer-readable storage medium includes instructions that, when executed by a processing device, cause the processing device to read a first entry that is associated with a first logical address from a first memory component. The first entry includes a first physical address to a segment of a logical-to-physical address map in a second memory component and an indication of whether the segment of the logical-to-physical address map is stored in the first memory component. The segment of the logical-to-physical address map includes a second entry associated with the first logical address. The instructions of example 8 further cause the processing device to write, based on a determination from the indication that the segment of the logical-to-physical address map is stored in the first memory component, a second physical address to the second entry in the first memory component.

Example 9 includes the subject matter of example 8. In example 9, the non-transitory computer-readable storage medium includes further instructions that, when executed by the processing device, cause the processing device to read, based on a determination from the indication that the segment of the logical-to-physical address map is not stored in the first memory component, the segment of the logical-to-physical address map from the first physical address of the second memory component. The instructions of example 9 further cause the processing device to write the segment of the logical-to-physical address map to a location in the first memory component and update the first entry associated with the first logical address in the first memory component to include an indication of the location.

Example 10 includes the subject matter of example 9. In example 10, the non-transitory computer-readable storage medium includes further instructions that, when executed by the processing device, cause the processing device to read another segment of the logical-to-physical address map from the location in the first memory component prior to writing the segment of the logical-to-physical address map to the location in the first memory component. The instructions of example 10 further cause the processing device to write the other segment of the logical-to-physical address map to the second memory component.

Example 11 includes the subject matter of example 10. In example 11, the non-transitory computer-readable storage medium includes further instructions that, when executed by the processing device, cause the processing device to update a third entry associated with the other segment of the logical-to-physical address map in the first memory component with an indication that the other segment of the logical-to-physical address map is not stored in the first memory component.

Example 12 includes the subject matter of any one of examples 8 to 11. In example 12, the non-transitory computer-readable storage medium includes further instructions that, when executed by the processing device, cause the processing device to determine, prior to writing the second physical address to the second entry in the first memory component, that the second entry in the first memory component contains a current physical address that matches a previous physical address.

Example 13 includes the subject matter of any one of examples 8 to 12. In example 13, a location of the first entry in the first memory component is identified based on a first portion of the first logical address, and a location of the second entry in the segment of the logical-to-physical address map in the second memory component is identified based on a second portion of the first logical address.

Example 14 includes the subject matter of any one of examples 8 to 13. In example 14, the indication is based on an encoding of at least a portion of the first entry.

Example 15 provides a system including a volatile memory component; a non-volatile memory component; and a processing device. The processing device is operatively coupled with the volatile memory component and the non-volatile memory component. The processing device is to read a first entry associated with a first logical address from the volatile memory component. The first entry includes a first physical address to a segment of a logical-to-physical address map in the non-volatile memory component and an indication of whether the segment of the logical-to-physical address map is stored in the volatile memory component. The segment of the logical-to-physical address map includes a second entry associated with the first logical address. The processing device of example 15 is further to write, based on a determination from the indication that the segment of the logical-to-physical address map is stored in the volatile memory component, a second physical address to the second entry in the volatile memory component.

Example 16 includes the subject matter of example 15. In example 16, the processing device is further to read, based on a determination from the indication that the segment of the logical-to-physical address map is not stored in the volatile memory component, the segment of the logical-to-physical address map from the first physical address of the non-volatile memory component. The processing device of example 16 is further to write the segment of the logical-to-physical address map to a location in the volatile memory component and update the first entry associated with the first logical address in the volatile memory component to include an indication of the location.

Example 17 includes the subject matter of example 16. In example 17, the processing device is further to read another segment of the logical-to-physical address map from the location in the volatile memory component prior to writing the segment of the logical-to-physical address map to the location in the volatile memory component. The processing device of example 17 is further to write the other segment of the logical-to-physical address map to the non-volatile memory component.

Example 18 includes the subject matter of example 17. In example 18, the processing device is further to update a third entry associated with the other segment of the logical-to-physical address map in the volatile memory component with an indication that the other segment of the logical-to-physical address map is not stored in the volatile memory component.

Example 19 includes the subject matter of any one of examples 15 to 18. In example 19, the processing device is further to determine, prior to writing the second physical address to the second entry in the volatile memory component, that the second entry in the volatile memory component contains a current physical address that matches a previous physical address.

Example 20 includes the subject matter of any one of examples 15 to 19. In example 20, a location of the first entry in the volatile memory component is identified based on a first portion of the first logical address, and a location of the second entry in the segment of the logical-to-physical address map in the non-volatile memory component is identified based on a second portion of the first logical address.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 120, may carry out the computer-implemented methods 300, 400, and/or 600 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
reading a first entry from a first memory component, the first entry associated with a first logical address, the first entry including a first physical address to a segment of a logical-to-physical address map in a second memory component and an indication of whether the segment of the logical-to-physical address map is stored in the first memory component, wherein the segment of the logical-to-physical address map includes a second entry associated with the first logical address; and
writing, based on a determination from the indication that the segment of the logical-to-physical address map is stored in the first memory component, a second physical address to the second entry in the first memory component.

2. The method of claim 1, further comprising:
reading, based on a determination from the indication that the segment of the logical-to-physical address map is not stored in the first memory component, the segment of the logical-to-physical address map from the first physical address of the second memory component;
writing the segment of the logical-to-physical address map to a location in the first memory component; and
updating the first entry associated with the first logical address in the first memory component to include an indication of the location.

3. The method of claim 2, further comprising:
reading another segment of the logical-to-physical address map from the location in the first memory component prior to writing the segment of the logical-to-physical address map to the location in the first memory component; and
writing the other segment of the logical-to-physical address map to the second memory component.

4. The method of claim 3, further comprising updating a third entry associated with the other segment of the logical-to-physical address map in the first memory component with an indication that the other segment of the logical-to-physical address map is not stored in the first memory component.

5. The method of claim 1, further comprising determining, prior to writing the second physical address to the second entry in the first memory component, that the second entry in the first memory component contains a current physical address that matches a previous physical address.

6. The method of claim 1, wherein a location of the first entry in the first memory component is identified based on a first portion of the first logical address and wherein a location of the second entry in the segment of the logical-to-physical address map in the second memory component is identified based on a second portion of the first logical address.

7. The method of claim 1, wherein the indication is based on an encoding of at least a portion of the first entry.

8. A non-transitory computer-readable storage medium comprising instructions that, when executed by a processing device, cause the processing device to:
read a first entry from a first memory component, the first entry associated with a first logical address, the first entry including a first physical address to a segment of a logical-to-physical address map in a second memory component and an indication of whether the segment of the logical-to-physical address map is stored in the first memory component, wherein the segment of the logical-to-physical address map includes a second entry associated with the first logical address; and
write, based on a determination from the indication that the segment of the logical-to-physical address map is stored in the first memory component, a second physical address to the second entry in the first memory component.

9. The non-transitory computer-readable storage medium of claim 8, wherein the processing device is further to:
read, based on a determination from the indication that the segment of the logical-to-physical address map is not stored in the first memory component, the segment of the logical-to-physical address map from the first physical address of the second memory component;
write the segment of the logical-to-physical address map to a location in the first memory component; and
update the first entry associated with the first logical address in the first memory component to include an indication of the location.

10. The non-transitory computer-readable storage medium of claim 9, wherein the processing device is further to:
read another segment of the logical-to-physical address map from the location in the first memory component prior to writing the segment of the logical-to-physical address map to the location in the first memory component; and
write the other segment of the logical-to-physical address map to the second memory component.

11. The non-transitory computer-readable storage medium of claim 10, wherein the processing device is further to update a third entry associated with the other segment of the logical-to-physical address map in the first memory component with an indication that the other segment of the logical-to-physical address map is not stored in the first memory component.

12. The non-transitory computer-readable storage medium of claim 8, wherein the processing device is further to determine, prior to writing the second physical address to the second entry in the first memory component, that the second entry in the first memory component contains a current physical address that matches a previous physical address.

13. The non-transitory computer-readable storage medium of claim 8, wherein a location of the first entry in the first memory component is identified based on a first portion of the first logical address and wherein a location of the second entry in the segment of the logical-to-physical address map in the second memory component is identified based on a second portion of the first logical address.

14. The non-transitory computer-readable storage medium of claim 8, wherein the indication is based on an encoding of at least a portion of the first entry.

15. A system comprising:
a volatile memory component;
a non-volatile memory component; and
a processing device, operatively coupled with the volatile memory component and the non-volatile memory component, to:
read a first entry from the volatile memory component, the first entry associated with a first logical address, the first entry including a first physical address to a segment of a logical-to-physical address map in the non-volatile memory component and an indication of whether the segment of the logical-to-physical address map is stored in the volatile memory component, wherein the segment of the logical-to-physical address map includes a second entry associated with the first logical address; and
write, based on a determination from the indication that the segment of the logical-to-physical address map is stored in the volatile memory component, a second physical address to the second entry in the volatile memory component.

16. The system of claim 15, wherein the processing device is further to:
read, based on a determination from the indication that the segment of the logical-to-physical address map is not stored in the volatile memory component, the segment of the logical-to-physical address map from the first physical address of the non-volatile memory component;
write the segment of the logical-to-physical address map to a location in the volatile memory component; and
update the first entry associated with the first logical address in the volatile memory component to include an indication of the location.

17. The system of claim 16, wherein the processing device is further to:
read another segment of the logical-to-physical address map from the location in the volatile memory component prior to writing the segment of the logical-to-physical address map to the location in the volatile memory component; and
write the other segment of the logical-to-physical address map to the non-volatile memory component.

18. The system of claim 17, wherein the processing device is further to update a third entry associated with the other segment of the logical-to-physical address map in the volatile memory component with an indication that the other segment of the logical-to-physical address map is not stored in the volatile memory component.

19. The system of claim 15, wherein the processing device is further to determine, prior to writing the second physical address to the second entry in the volatile memory component, that the second entry in the volatile memory component contains a current physical address that matches a previous physical address.

20. The system of claim 15, wherein a location of the first entry in the volatile memory component is identified based on a first portion of the first logical address and wherein a location of the second entry in the segment of the logical-to-physical address map in the non-volatile memory component is identified based on a second portion of the first logical address.
